(19) United States
(12) Patent Application Publication
(10) Pub. No.: US 2017/0364356 A1
(43) Pub. Date: Dec. 21, 2017

(54) TECHNIQUES FOR IMPLEMENTING STORE INSTRUCTIONS IN A MULTI-SLICE PROCESSOR ARCHITECTURE

(71) Applicant: INTERNATIONAL BUSINESS MACHINES CORPORATION, ARMONK, NY (US)

(72) Inventors: SALMA AYUB, AUSTIN, TX (US); MAARTEN J. BOERSMA, BOEBLINGEN (DE); SUNDEEP CHADHA, AUSTIN, TX (US); DAVID A. HRUSECKY, CEDAR PARK, TX (US); JENNIFER L. MOLNAR, CEDAR PARK, TX (US); DUNG Q. NGUYEN, AUSTIN, TX (US)

(21) Appl. No.: 15/184,106

(22) Filed: Jun. 16, 2016

(51) Int. Cl. G06F 9/30; G06F 12/0855; G06F 12/0875

(52) U.S. Cl. CPC G06F 9/30043; G06F 12/0875; G06F 12/0855; G06F 2212/452

(57) ABSTRACT

A technique for operating a processor includes receiving, at an issue queue, a store instruction that has an associated address generation (AGN) operation and an associated data operation. The AGN operation is issued to AGN logic associated with a pipeline slice in response to all source operands for the AGN operation being ready. The AGN logic is configured to generate an address for the store instruction. Confirmation, for the AGN operation is received. The confirmation includes an indication of the pipeline slice that performed the AGN operation. In response to receiving the confirmation and a source operand for the data operation being ready, the issue queue issues the data operation to data logic associated with the pipeline slice indicated by the confirmation. The data logic is configured to format data for the store instruction.

### BACKGROUND

The present disclosure is generally directed to implementing store instructions and, more specifically to techniques for implementing store instructions in a multi-slice processor architecture.

In general, on-chip parallelism of a processor design may be increased through superscalar techniques that attempt to exploit instruction level parallelism (ILP) and/or through multithreading, which attempts to exploit thread level parallelism (TLP). Superscalar refers to executing multiple instructions at the same time, and multithreading refers to executing instructions from multiple threads within one processor chip at the same time. Simultaneous multithreading (SMT) is a technique for improving the overall efficiency of superscalar processors with hardware multithreading. In general, SMT permits multiple independent threads of execution to better utilize resources provided by modern processor architectures. In SMT processor pipeline stages are time shared between active threads.

In computer science, a thread of execution (or thread) is usually the smallest sequence of programmed instructions that can be managed independently by an operating system (OS) scheduler. A thread is usually considered a light-weight process, and the implementation of threads and processes usually differs between OSs, but in most cases a thread is included within a process. Multiple threads can exist within the same process and share resources, e.g., memory, while different processes usually do not share resources. In a processor with multiple processor cores, each processor core may execute a separate thread simultaneously. In general, a kernel of an OS allows programmers to manipulate threads via a system call interface.

In a known processor architecture that implements the POWER® instruction set architecture (ISA), a load/store unit (LSU) has been configured to execute all load and store instructions, manage interfacing a processor core with other processor systems through a unified level two (L2) cache and a non-cacheable unit (NCU), and implement address translation. The LSU in the known processor architecture included two symmetric load pipelines (L0 and L1) and two symmetric load/store pipelines (LS0 and LS1). Each of the LS0 and LS1 pipelines were configured to execute a load or a store operation in a single processor cycle and each of the L0 and L1 pipelines were configured to execute a load operation in a single processor cycle. Simple fixed-point operations could also be executed in each pipeline in the LSU, with a latency of three cycles.

In single thread (ST) mode, a given load instruction could execute in any LS0, LS1, L0, or L1 pipeline and a given store instruction could execute in any LS0 or LS1 pipeline. In SMT2 mode (two executable threads), SMT4 mode (four executable threads), and SMT8 mode (eight executable threads), load/store instructions from one-half of the threads executed in the LS0 and L0 pipelines, while instructions from the other one-half of the threads executed in the LS1 and L1 pipelines. Load/store instructions were issued to the LSU out-of-order, with a bias toward the oldest instructions first. Store instructions were issued twice (i.e., an address generation (AGN) operation was issued to an LS0 or LS1 pipeline, while a data operation (to retrieve the contents of a register being stored) was issued to an L0 or L1 pipeline). The LSU was configured to ensure the effect of architectural program order of execution of the load/store instructions, even though the instructions could be issued and executed out-of-order, by employing two reorder queues: i.e., a store reorder queue (SRQ) and a load reorder queue (LRQ).

### BRIEF SUMMARY

A technique for operating a processor includes receiving, at an issue queue, a store instruction that has an associated address generation (AGN) operation and an associated data operation. The AGN operation is issued to AGN logic associated with a pipeline slice in response to all source operands for the AGN operation being ready. The AGN logic is configured to generate an address for the store instruction. Confirmation, for the AGN operation is received. The confirmation includes an indication of the pipeline slice that performed the AGN operation. In response to receiving the confirmation and a source operand for the data operation being ready, the issue queue issues the data operation to data logic associated with the pipeline slice indicated by the confirmation. The data logic is configured to format data for the store instruction.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

The above as well as additional objectives, features, and advantages of the present invention will become apparent in the following detailed written description.

### BRIEF DESCRIPTION OF THE DRAWINGS

The description of the illustrative embodiments is to be read in conjunction with the accompanying drawings, wherein:

FIG. 1 is a diagram of a relevant portion of an exemplary data processing system environment that includes a simultaneous multithreading (SMT) data processing system that is configured to handle store instructions (stores) according to the present disclosure;

FIG. 2 is a diagram of a relevant portion of an exemplary processor pipeline of the data processing system of FIG. 1;

FIG. 3 is a diagram of a relevant portion of exemplary execution slices of an execution pipeline in conjunction with associated exemplary load/store (LS) slices of a LS pipeline that are configured to handle stores according to the present disclosure;

FIG. 4 is a diagram of a relevant components of the exemplary execution slices and the exemplary LS slices of FIG. 3 with additional detail;

FIG. 5 is a diagram of a relevant portion of an exemplary data address recirculation queue (DARQ), according to one embodiment of the present disclosure;

FIG. 6 is another diagram of a relevant portion of an exemplary DARQ, according to another embodiment of the present disclosure;

FIG. 7 is yet another diagram of a relevant portion of an exemplary DARQ, according to yet another embodiment of the present disclosure;

FIG. 8 is a flowchart of an exemplary process implemented by logic associated with a unified issue queue, configured according to one embodiment of the present disclosure; and

FIG. 9 is a flowchart of an exemplary process implemented by logic associated with a DARQ, configured according to one embodiment of the present disclosure.

### DETAILED DESCRIPTION

The illustrative embodiments provide a method, a data processing system, and a processor configured to implement store instructions in a multi-slice processor architecture.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof.

It should be understood that the use of specific component, device, and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized. As used herein, the term ‘coupled’ may encompass a direct connection between components or elements or an indirect connection between components or elements utilizing one or more intervening components or elements.

The present disclosure is directed to techniques for handling an address generation (AGN) operation and a data operation of a store (ST) instruction in a multi-slice design that requires the AGN and data operations of the store instruction be sent to a same slice associated with an execution pipeline and a load/store (LS) pipeline included within a load/store unit (LSU). It should be appreciated that execution slices and LS slices may both be implemented within a same LS pipeline or the execution slices may be implemented within an execution pipeline that is distinct from an LS pipeline. A data processing system that employs shared memory communication (SMC) may, for example, partition a sixty-four kilobyte (kB) level one (L1) data cache of an LS pipeline into eight 8 kB blocks, i.e., one 8 kB data cache block for each of eight LS slices of the LS pipeline. In this case, each data cache block stores a double word (DW) sized piece of data (where a DW is eight bytes). As one example, in a data processing system in which an LSU includes two LS pipelines (e.g., LS0 and LS1 pipelines) that are each partitioned into eight slices and one-hundred twenty-eight byte cache lines are implemented, slices 0-7 of the LS0 pipeline may be configured to process respective even double words (DWs), e.g., DW0, DW2, DW4, DW6, DW8, DW10, DW12, and DW14) of the cache line and slices 0-7 of the LS1 pipeline may be configured to process respective odd DWs, e.g., DW1, DW3, DW5, DW7, DW9, DW11, DW13, and DW15, of the cache line. In this case, a unified issue queue may include two distinct unified issue queues, i.e., one unified issue queue for the even DWs (i.e., the LS0 pipeline) and one unified issue queue for the odd DWs (i.e., the LS1 pipeline).

As another example, a data processing system that employs SMC may partition a sixty-four kB L1 data cache of an LS pipeline into four 16 kB blocks, i.e., one 16 kB data cache block for each of four LS slices of the LS pipeline. In this case, each data cache block stores a quad word (QW) sized piece of data (where a QW is sixteen bytes). In a data processing system in which an LSU includes two LS pipelines (e.g., LS0 and LS1 pipelines) that are each partitioned into four slices and one-hundred twenty-eight byte cache lines are implemented, slices 0-3 of the LS0 pipeline may be configured to process respective even quad words (QWs), e.g., QW0, QW2, QW4, and QW6, of a cache line and slices 0-3 of the LS1 pipeline may be configured to process respective odd QWs, e.g., QW1, QW3, QW5, and QW7, of the cache line. In the above-described SMC multi-slice designs, when an AGN operation is issued to a particular slice an associated data operation must also be issued to the same slice (as the data operation does not have a separate identifier). It should be appreciated that an LS pipeline configured according to the present disclosure may have a different number of slices than those described herein.

According to one or more embodiments of the present disclosure, when a store instruction is dispatched to a unified issue queue, the store instruction occupies one entry in the unified issue queue. In various embodiments, a store instruction is issued in two separate operations (i.e., an address generation (AGN) operation and a data operation), each of which are identified by a same instruction tag (ITAG). In one or more embodiments, the AGN operation is issued from an LSU port of the unified issue queue with an associated ITAG and the data operation is issued from a fixed-point unit (FXU) port of the unified issue queue with the associated ITAG.

In a typical implementation, when a store instruction is dispatched to a unified issue queue (UIQ), the UIQ issues an associated AGN operation (in association with an ITAG) to a pipeline slice when all source operands for the AGN operation are ready. After the AGN operation is issued, an associated data operation is held in the UIQ until confirmation is received as to which slice received the AGN operation. Following confirmation of which slice received the AGN operation, the UIQ issues the data operation (in association with the ITAG) to the same slice when a source operand for the data operation is ready.

During the AGN operation, an effective address (EA) for the store instruction is stored in a data address recirculation queue (DARQ) associated with an assigned slice. In a first embodiment, a queue position (QPOS) in the DARQ, the ITAG, and the slice location (e.g., three EA bits that indicate which of eight slices is handling the AGN operation or two EA bits that indicate which of four slices is handling the AGN operation) are then returned to the UIQ. In an alternative second embodiment, only the ITAG and the slice location are returned from the DARQ to the UIQ. In the first embodiment, the UIQ writes the queue position and the slice location into the entry of the store instruction in the UIQ. In the second embodiment, the UIQ writes the slice location in the entry associated with the ITAG. In the first embodiment, when the data operation is ready to be issued, the data operation is issued with the queue position, the ITAG, and the slice location. In the second embodiment, when the data operation is ready to be issued, the data operation is issued with the ITAG and the slice location.

In the first embodiment, the slice location is used to route the data operation to the correct slice and the queue position is used to write the results of the data operation (i.e., the data) into the entry in the DARQ that is associated with the AGN operation. In the second embodiment, the slice location is used to route the data operation to the correct slice and the results of the data operation (i.e., the data) and the ITAG are written into a new entry in the DARQ. In the second embodiment, subsequent to sending the confirmation to the UIQ, the DARQ may issue the AGN operation, which flows to an associated load/store address queue (LSAQ) and then to an associated store reorder queue (SRQ), and then invalidate the associated entry in the DARQ. For example, if bits of an address associated with an AGN operation indicate that slice zero is to be utilized to generate the EA then slice zero is then utilized to execute the data operation (i.e., format the store data). As another example, if bits of an address associated with a AGN operation indicate that slice five is to be utilized to generate the EA then slice five is then utilized to execute the data operation (i.e., format the store data).

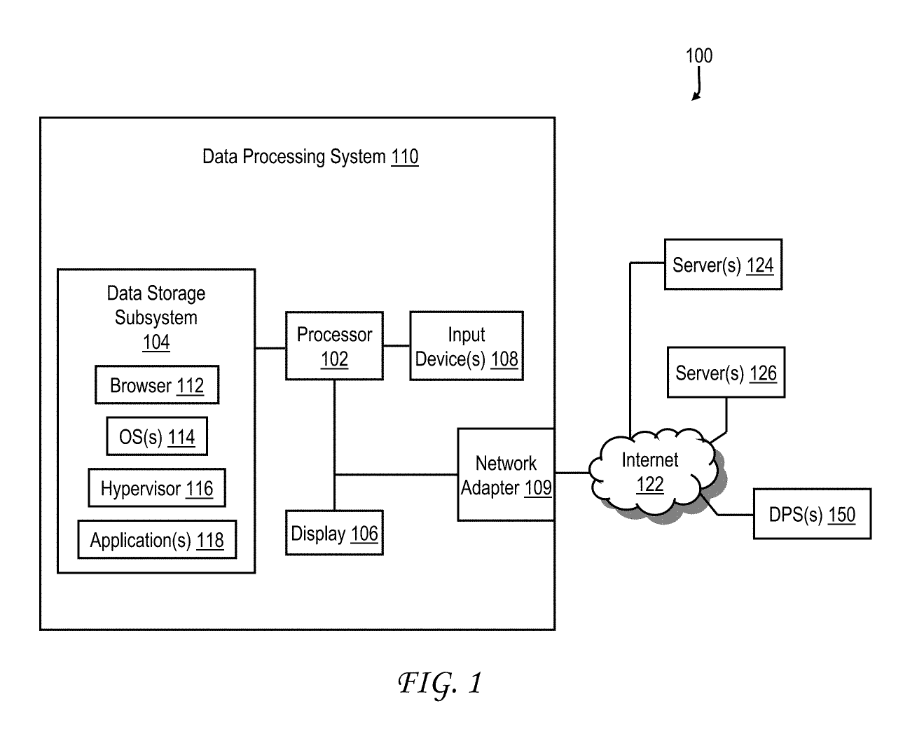

With reference to FIG. 1, an exemplary data processing environment 100 is illustrated that includes a simultaneous multithreading (SMT) data processing system 110 that is configured to implement store instructions in a multi-slice processor architecture, according to the present disclosure. Data processing system 110 may take various forms, such as workstations, laptop computer systems, notebook computer systems, desktop computer systems or servers and/or clusters thereof. Data processing system 110 includes one or more processors 102 (which may include one or more processor cores for executing program code) coupled to a data storage subsystem 104, optionally a display 106, one or more input devices 108, and a network adapter 109. Data storage subsystem 104 may include, for example, application appropriate amounts of various memories (e.g., dynamic random access memory (DRAM), static RAM (SRAM), and read-only memory (ROM)), and/or one or more mass storage devices, such as magnetic or optical disk drives.

Data storage subsystem 104 includes one or more operating systems (OSs) 114 for data processing system 110. Data storage subsystem 104 also includes application programs, such as a browser 112 (which may optionally include customized plug-ins to support various client applications), a hypervisor (or virtual machine monitor (VMM)) 116 for managing one or more virtual machines (VMs) as instantiated by different OS images, and other applications (e.g., a word processing application, a presentation application, and an email application) 118.

Display 106 may be, for example, a cathode ray tube (CRT) or a liquid crystal display (LCD). Input device(s) 108 of data processing system 110 may include, for example, a mouse, a keyboard, haptic devices, and/or a touch screen. Network adapter 109 supports communication of data processing system 110 with one or more wired and/or wireless networks utilizing one or more communication protocols, such as 802.x, HTTP, simple mail transfer protocol (SMTP), etc. Data processing system 110 is shown coupled via one or more wired or wireless networks, such as the Internet 122, to various file servers 124 and various web page servers 126 that provide information of interest to the user of data processing system 110. Data processing environment 100 also includes one or more data processing systems 150 that are configured in a similar manner as data processing system 110. In general, data processing systems 150 represent data processing systems that are remote to data processing system 110 and that may execute OS images that may be linked to one or more OS images executing on data processing system 110.

Those of ordinary skill in the art will appreciate that the hardware components and basic configuration depicted in FIG. 1 may vary. The illustrative components within data processing system 110 are not intended to be exhaustive, but rather are representative to highlight components that may be utilized to implement the present invention. For example, other devices/components may be used in addition to or in place of the hardware depicted. The depicted example is not meant to imply architectural or other limitations with respect to the presently described embodiments.

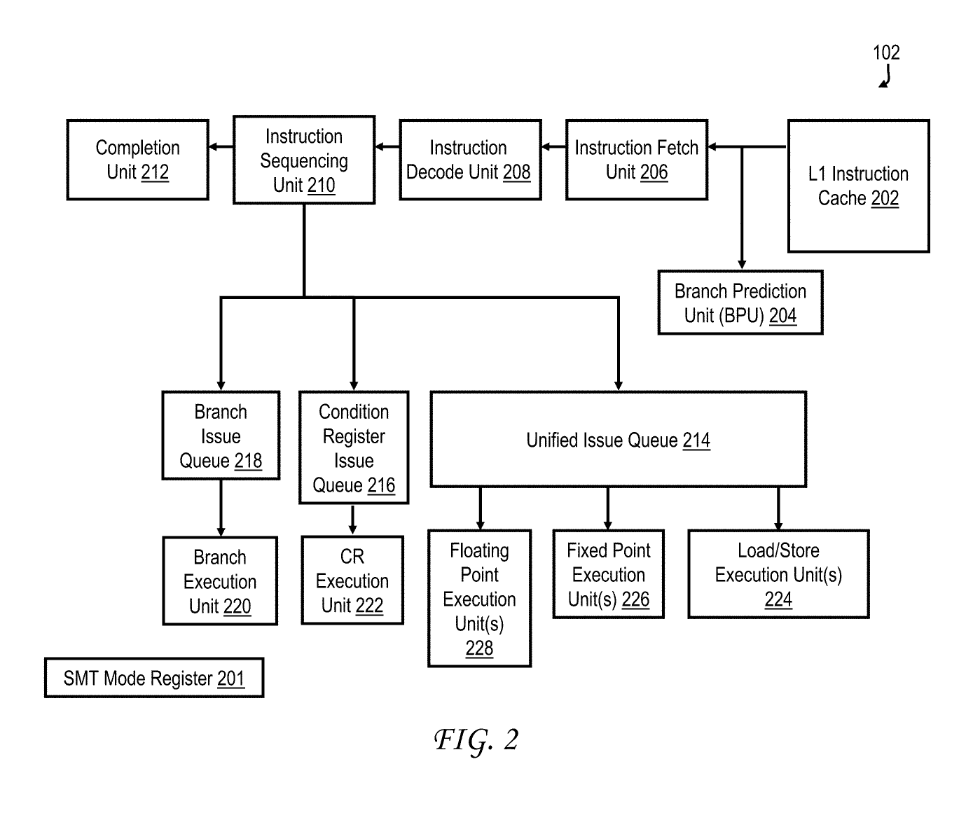

With reference to FIG. 2, relevant components of processor 102 are illustrated in additional detail. Processor 102 includes a level one (L1) instruction cache 202 from which instruction fetch unit (IFU) 206 fetches instructions. In one or more embodiments, IFU 206 may support a multi-cycle (e.g., three-cycle) branch scan loop to facilitate scanning a fetched instruction group for branch instructions predicted ‘taken’, computing targets of the predicted ‘taken’ branches, and determining if a branch instruction is an unconditional branch or a ‘taken’ branch. Fetched instructions are also provided to branch prediction unit (BPU) 204, which predicts whether a branch is ‘taken’ or ‘not taken’ and a target of predicted ‘taken’ branches.

In one or more embodiments, BPU 204 includes a branch direction predictor that implements a local branch history table (LBHT) array, global branch history table (GBHT) array, and a global selection (GSEL) array. The LBHT, GBHT, and GSEL arrays (not shown) provide branch direction predictions for all instructions in a fetch group (that may include up to eight instructions). The LBHT, GBHT, and GSEL arrays are shared by all threads. The LBHT array may be directly indexed by bits (e.g., ten bits) from an instruction fetch address provided by an instruction fetch address register (IFAR). The GBHT and GSEL arrays may be indexed by the instruction fetch address hashed with a global history vector (GHV), e.g., a 21-bit GHV reduced down to eleven bits, which provides one bit per allowed thread. The value in the GSEL array may be employed to select between the LBHT and GBHT arrays for the direction of the prediction of each individual branch. In various embodiments, BPU 204 is also configured to predict a target of an indirect branch whose target is correlated with a target of a previous instance of the branch utilizing a pattern cache.

IFU 206 provides fetched instructions to instruction decode unit (IDU) 208 for decoding. IDU 208 provides decoded instructions to instruction sequencing unit (ISU) 210 for dispatch. In one or more embodiments, ISU 210 is configured to dispatch instructions to various issue queues, rename registers in support of out-of-order execution, issue instructions from the various issues queues to the execution pipelines, complete executing instructions, and handle exception conditions. In various embodiments, ISU 210 is configured to dispatch instructions on a group basis. In a single thread (ST) mode, ISU 210 may dispatch a group of up to eight instructions per cycle. In simultaneous multi-thread (SMT) mode, ISU 210 may dispatch two groups per cycle from two different threads and each group can have up to four instructions. It should be appreciated that in various embodiments, all resources (e.g., renaming registers and various queue entries) must be available for the instructions in a group before the group can be dispatched. In one or more embodiments, an instruction group to be dispatched can have at most two branch and six non-branch instructions from the same thread in ST mode. In one or more embodiments, if there is a second branch the second branch is the last instruction in the group. In SMT mode, each dispatch group can have at most one branch and three non-branch instructions.

In one or more embodiments, ISU 210 employs an instruction completion table (ICT) that tracks information for each of two-hundred fifty-six (256) instruction operations (IOPs). In one or more embodiments, flush generation for the core is handled by ISU 210. For example, speculative instructions may be flushed from an instruction pipeline due to branch misprediction, load/store out-of-order execution hazard detection, execution of a context synchronizing instruction, and exception conditions. ISU 210 assigns instruction tags (ITAGs) to manage the flow of instructions. In one or more embodiments, each ITAG has an associated valid bit that is cleared when an associated instruction completes. Instructions are issued speculatively, and hazards can occur, for example, when a fixed-point operation dependent on a load operation is issued before it is known that the load operation misses a data cache. On a mis-speculation, the instruction is rejected and re-issued a few cycles later.

Following execution of dispatched instructions, ISU 210 provides the results of the executed dispatched instructions to completion unit 212. Depending on the type of instruction, a dispatched instruction is provided to branch issue queue 218, condition register (CR) issue queue 216, or unified issue queue 214 for execution in an appropriate execution unit. Branch issue queue 218 stores dispatched branch instructions for branch execution unit 220. CR issue queue 216 stores dispatched CR instructions for CR execution unit 222. Unified issued queue 214 stores instructions for floating point execution unit(s) 228, fixed-point execution unit(s) 226, load/store execution unit(s) 224 included within a load/store unit (LSU), among other execution units. Processor 102 also includes an SMT mode register 201 whose bits may be modified by hardware or software (e.g., an operating system (OS)). It should be appreciated that units that are not necessary for an understanding of the present disclosure have been omitted for brevity and that described functionality may be located in a different unit.

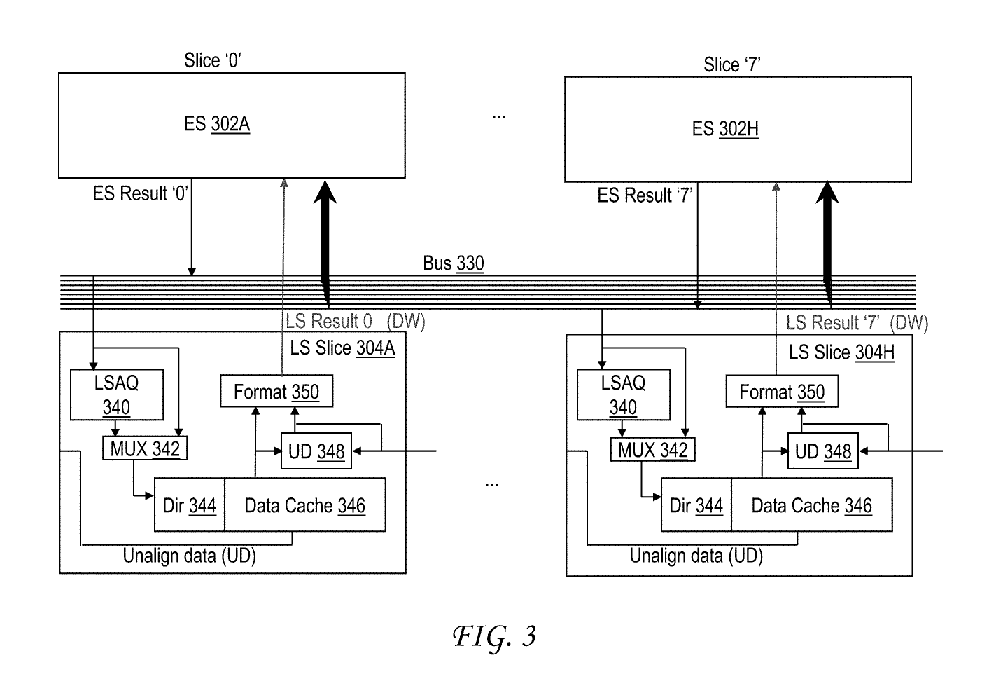

With reference to FIG. 3, eight execution slices (ESs) 302 of an execution pipeline and eight load/store (LS) slices 304 of an LS pipeline are illustrated as communicating via a bus 330. In one or more embodiments, each ES 302 includes logic for generating an effective address (EA) for a store instruction and logic for formatting data associated with the EA. In one or more embodiments, each LS slice 304 includes a load/store address queue (LSAQ) 340 for storing EAs, a MUX 342, a data cache 346 with an associated directory 344, an unaligned data (UD) unit 348 and a format unit 350, among other components. A different portion of bus 330 is coupled to an input of each LSAQ 340 in each LS slice 304. Each LSAQ 340 is configured to queue addresses (or at least a portion of an address, e.g., the twelve lower order address bits) associated with load and store operations. An output of LSAQ 340 is coupled to a first input of MUX 342. A second input of MUX 342 is coupled to a portion of bus 330. An output of MUX 342 provides an address from a selected input to a directory 344 associated with data cache 346 in order to store data in (or load data from) data cache 346. UD unit 348 is used to access load data associated with an unaligned load (e.g., a load whose data crosses a DW boundary and portions of which reside in data caches 346 of two different slices). Format unit 350 is configured to format unaligned data and data received from data cache 346.

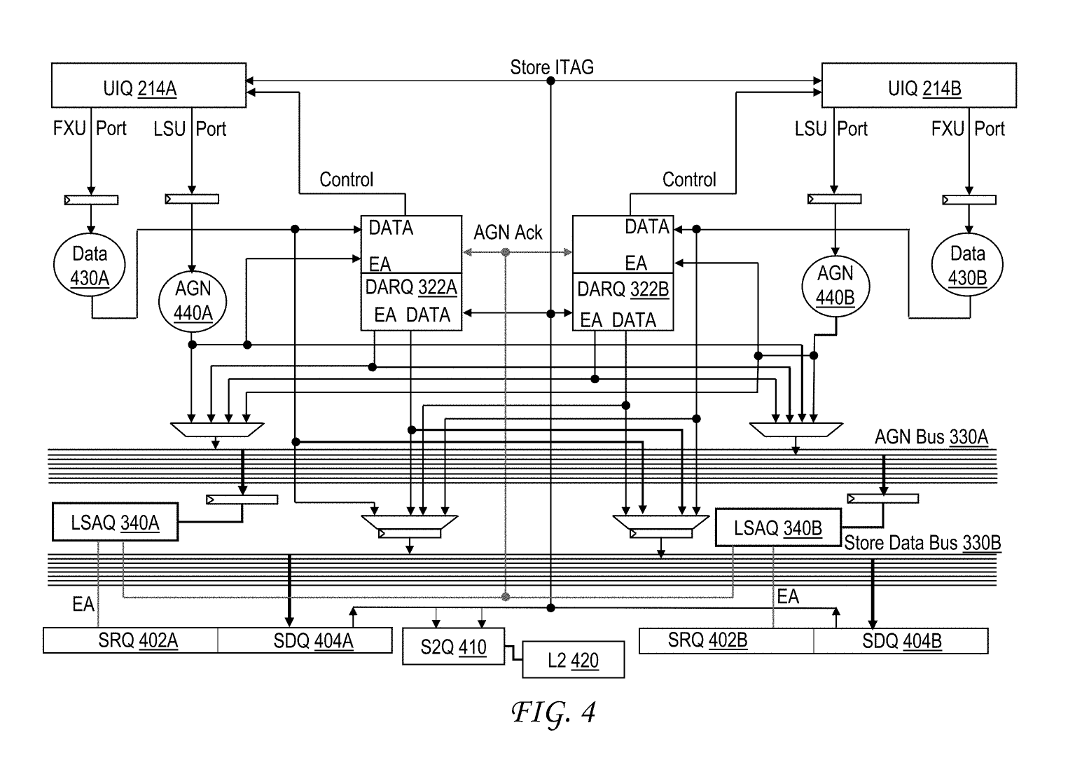

With reference to FIG. 4, relevant portions of execution slices 302, bus 330, and LS slices 304 are illustrated in additional detail in conjunction with unified issue queue (UIQ) 214, which includes UIQ 214A for even slices (i.e., LS0) and UIQ 214B for odd slices (i.e., LS1). While only portions of two slices are illustrated in FIG. 4, it should be appreciated that additional slices may be implemented in a processor configured according to the present disclosure. More specifically, UIQ 214A is used to queue store instructions for even slices (e.g., slice ‘0’, ‘2’, etc.) and UIQ 214B is used to queue store instructions for odd slices (e.g., ‘1’, ‘3’, etc.). Assuming a store instruction is queued in UIQ 214A and is to be processed by slice ‘0’, when an AGN operation for the store instruction is issued from an LSU port of UIQ 214A, AGN logic 440A (e.g., logic implemented within ES 302A) calculates an effective address (EA) for the store instruction. The EA is then stored in a data address recirculation queue (DARQ) 322A associated with slice ‘0’.

In the first embodiment, DARQ 322A (e.g., located within ES 302A) then reports a queue position (QPOS), an ITAG, and a pipeline slice location (e.g., three EA bits that indicate which of eight slices is handling the AGN operation or two EA bits that indicate which of four slices is handling the AGN operation) to UIQ 214A. In the second embodiment, DARQ 322A then only reports an ITAG of the store instruction and pipeline slice location to UIQ 214A. In the first embodiment, UIQ 214A then initiates writing the queue position and the slice location into the entry of the store instruction (as indentified by the reported ITAG), in UIQ 214A. In the second embodiment, UIQ 214A then initiates writing the slice location into the entry of the store instruction (as identified by the reported ITAG) in UIQ 214A. In the first embodiment, when the data operation for the store instruction is ready to be issued from UIQ 214A, the data operation is issued with the queue position, the ITAG, and the slice location from the FXU port of UIQ 214A to data logic 430A (e.g., logic implemented within ES 302A). In the second embodiment, when the data operation for the store instruction is ready to be issued from UIQ 214A, the data operation is issued with the ITAG and the slice location from the FXU port of UIQ 214A to data logic 430A (e.g., logic implemented within ES 302A).

In the first embodiment, data logic 430A then formats the data for the store instruction and provides the formatted data to DARQ 322A, along with the queue position, the ITAG, and the slice location. Logic of DARQ 322A then writes the formatted data into the queue position with the EA for the store instruction. In the second embodiment, data logic 430A then formats the data for the store instruction and provides the formatted data to DARQ 322A, along with the ITAG and the slice location. In the second embodiment, logic of DARQ 322A then writes the formatted data and the ITAG into a new entry in DARQ 322A.

In the first embodiment, when the entry in the DARQ 322A is ready to be written to data cache 346 for slice ‘0’, the EA is multiplexed onto a slice ‘0’ portion of AGN bus 330A of bus 330 and the data is multiplexed onto a slice ‘0’ portion of store data bus 330B of bus 330. LSAQ0 340A then receives the EA for the store instruction from the slice ‘0’ portion of AGN bus 330A, stores the EA and other control information (along with the ITAG) in a store reorder queue (SRQ) 402A, and provides an AGN acknowledgement (AGN Ack) to DARQ 322A to initiate invalidation of an associated entry in DARQ 322A. A store data queue (SDQ) 404A receives the data for the store instruction from the slice ‘0’ portion of data bus 330B and stores the data in an entry in SDQ 404A. LSAQ0 340A is also configured to initiate storage of the formatted data in an associated data cache 346 in association with the EA. In the second embodiment, as mentioned above, each store instruction has two associated entries (i.e., an EA entry and a data entry) in DARQ 322A that may be issued from DARQ 322A at different times.

Assuming a store instruction is queued in UIQ 214B, is to be processed by slice ‘1’, and is operating according to the first embodiment, when an AGN operation for the store instruction is issued from an LSU port of UIQ 214B AGN logic 440B (e.g., logic implemented within ES 302B) calculates an EA for the store instruction. The EA is then stored in a DARQ 322B associated with slice ‘1’. In the first embodiment, DARQ 322B then reports a queue position, an ITAG, and pipeline slice location (e.g., three EA bits that indicate which of eight slices is handling the AGN operation or two EA bits that indicate which of four slices is handling the AGN operation) to UIQ 214B. UIQ 214B then initiates writing the queue position and the slice location into the entry of the store instruction (as indicated by the ITAG) in UIQ 214B. When the data operation for the store instruction is ready to be issued from UIQ 214B, the data operation is issued with the queue position, the ITAG, and the slice location from the FXU port of UIQ 214B to data logic 430B (e.g., logic implemented within ES 302B). Data logic 430B then formats the data for the store instruction and provides the formatted data to DARQ 322B, along with the queue position and the ITAG. The DARQ 322B then writes the formatted data into the queue position with the EA for the store instruction in DARQ 322B. When the entry in the DARQ 322B is ready to be written to data cache 346 for slice ‘1’, the EA is multiplexed onto a slice ‘1’ portion of AGN bus 330A of bus 330 and the data is multiplexed onto a slice ‘1’ portion of store data bus 330B of bus 330. LSAQ0 340B then receives the EA for the store instruction from the slice ‘1’ portion of AGN bus 330B, stores the EA and other control information in a store reorder queue (SRQ) 402B, and provides a AGN Ack to DARQ 322B to initiate invalidation of an associated entry in DARQ 322B. A store data queue (SDQ) 404B receives the data for the store instruction (as identified by the ITAG) from the slice ‘1’ portion of data bus 330B and stores the data in an entry in SDQ 404B. A unified store queue (S2Q) 410 is configured to collect stores for all implemented slices (only two of which are shown in FIG. 4) from SRQs 402 and SDQs 404. The stores queued in S2Q 410 are eventually transferred to lower level memory (e.g., level two (L2) memory) 420.

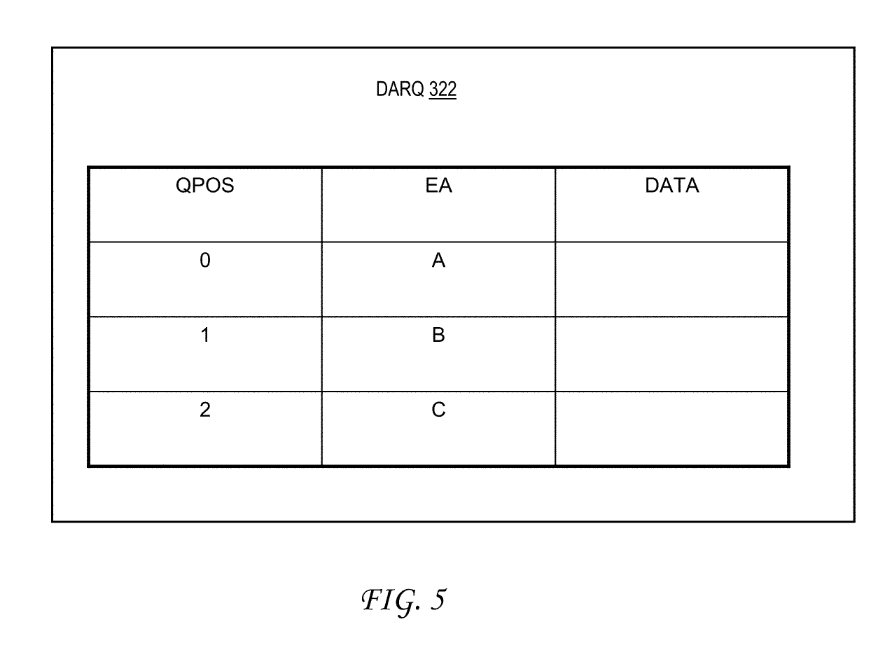

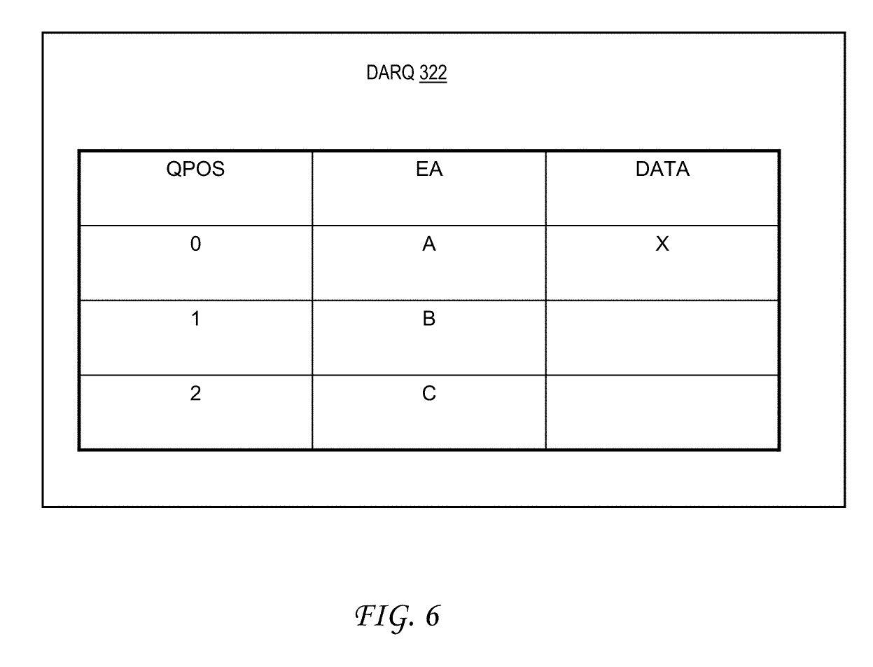

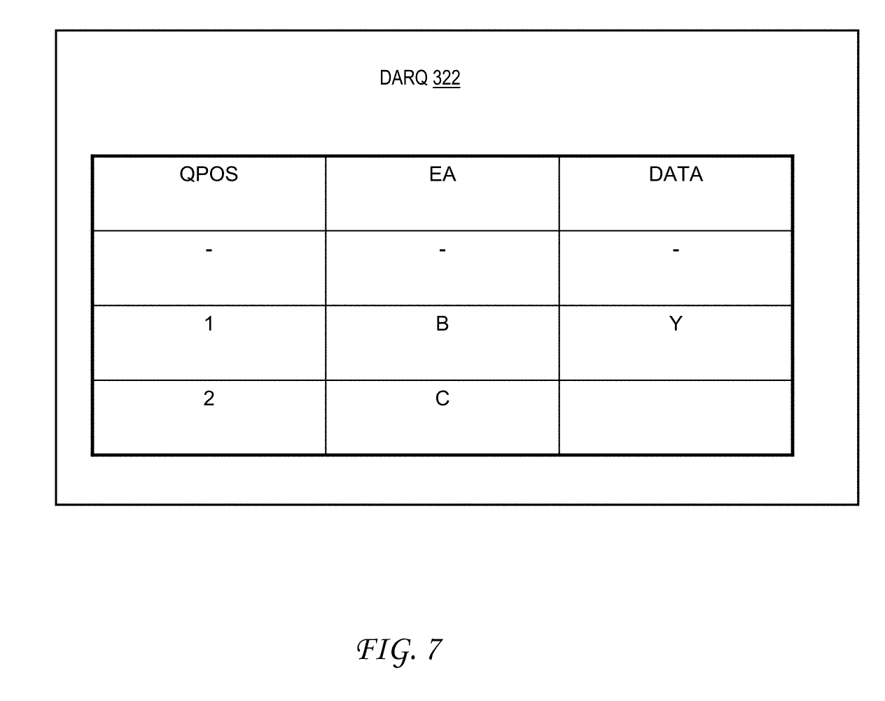

With reference to FIG. 5, DARQ 322 is illustrated as including three valid entries that do not yet have associated store data. An entry in queue position (QPOS) ‘0’ has an EA of ‘A’, an entry in queue position ‘1’ has an EA of ‘B’, and an entry in queue position ‘2’ has an EA of ‘C’. With reference to FIG. 6, DARQ 322 is further illustrated as including three valid entries, two entries which do not yet have associated store data. The entry in queue position ‘0’ has an EA of ‘A’ and associated store data ‘X’. The associated store data in queue position ‘0’ is ready to be written to an associated data cache 346 using the EA ‘A’. The entries in queue positions ‘1’ and ‘2’ do not yet have associated store data. With reference to FIG. 7, DARQ 322 is further illustrated as only including two valid entries (at queue positions ‘1’ and ‘2’) and an invalid entry (at queue position ‘0’), as the store data previously queued in queue position ‘0’ has been written to an associated data cache 346 and the entry has been invalidated. The entry in queue position ‘1’ now has associated store data ‘Y’ and the entry in queue position ‘2’ does not yet have associated store data. The associated store data in queue position ‘1’ is now ready to be written to an associated data cache 346 using the EA ‘B’. While only three entries are illustrated in DARQ 322, it should be appreciated that a DARQ configured according to the present disclosure may include more or less than three entries. It should also be appreciated that each entry in DARQ 322 of FIGS. 5-7 also includes an associated ITAG (not shown for brevity) and that DARQ 322 of FIGS. 5-7 is illustrated according to the first embodiment. In the second embodiment (i.e., where queue position is not reported to UIQ 214), an EA for a store instruction and data for the store instruction are written into different entries in DARQ 322 and are independently issued from DARQ 322.

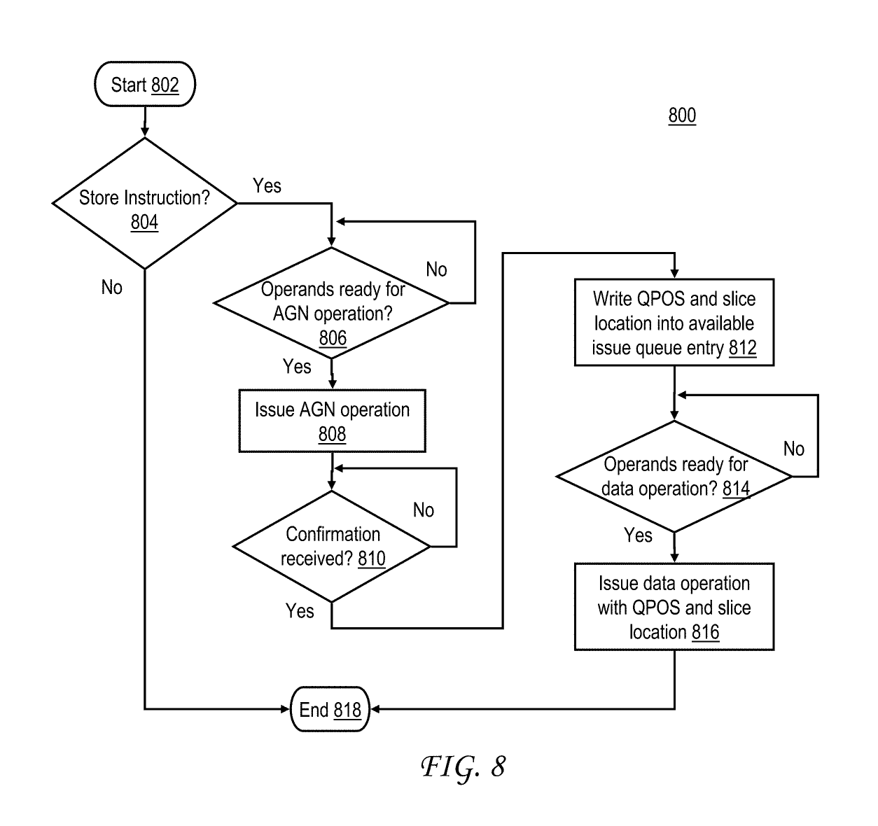

With reference to FIG. 8, an exemplary process 800 for handling a store instruction, according to an embodiment of the present disclosure, is illustrated. Process 800 is initiated in block 802 by, for example, UIQ 214 in response to, for example, receipt of a dispatched instruction. UIQ 214 may be either UIQ 214A, which services even slices, or UIQ 214B, which services odd slices. Next, in decision block 804, UIQ 214 determines whether the dispatched instruction is a store instruction. In response to the dispatched instruction not being a store instruction control transfers to from block 804 to block 818, where process 800 terminates. In response to the dispatched instruction being a store instruction in block 804 control transfers to decision block 806. In block 806, UIQ 214 determines whether operands for an AGN operation of the store instruction are ready such that the AGN operation can be issued to an assigned AGN logic 440 for address calculation. In response to the operands not being ready control loops on block 806. In response to the operands being ready in block 806 control transfers to block 808.

In block 808 UIQ 214 issues the AGN operation to an appropriate AGN logic 440, which generates an EA (which is stored in an available entry in DARQ 322) for the store instruction. Next, in decision block 810, UIQ 214 determines whether confirmation (e.g., a control signal including a queue position where the EA was stored in DARQ 322, an ITAG, and a slice location or a control signal including an ITAG and a slice location) has been received from DARQ 322. In response to the confirmation not being received control loops on block 810. In response to the confirmation being received in block 810 control transfers to block 812. In block 812, UIQ 214 writes the slice location (and in the first embodiment the queue position) into an associated issue queue entry (i.e., the entry associated with the store instruction based on the ITAG). Next, in decision block 814, UIQ 214 determines whether operands are ready for a data operation associated with the store instruction (which is identified by the store instruction ITAG). In response to the operands being ready for the data operation in block 814 control transfers to block 816, where UIQ 214 issues the data operation with the ITAG and the slice location (and in the first embodiment the queue position) to data logic 430, which formats the data for the store instruction (which is then stored in an entry (i.e., in the first embodiment the entry associated with the EA or in the second embodiment a new entry) in DARQ 322). Following block 816 control transfers to block 818.

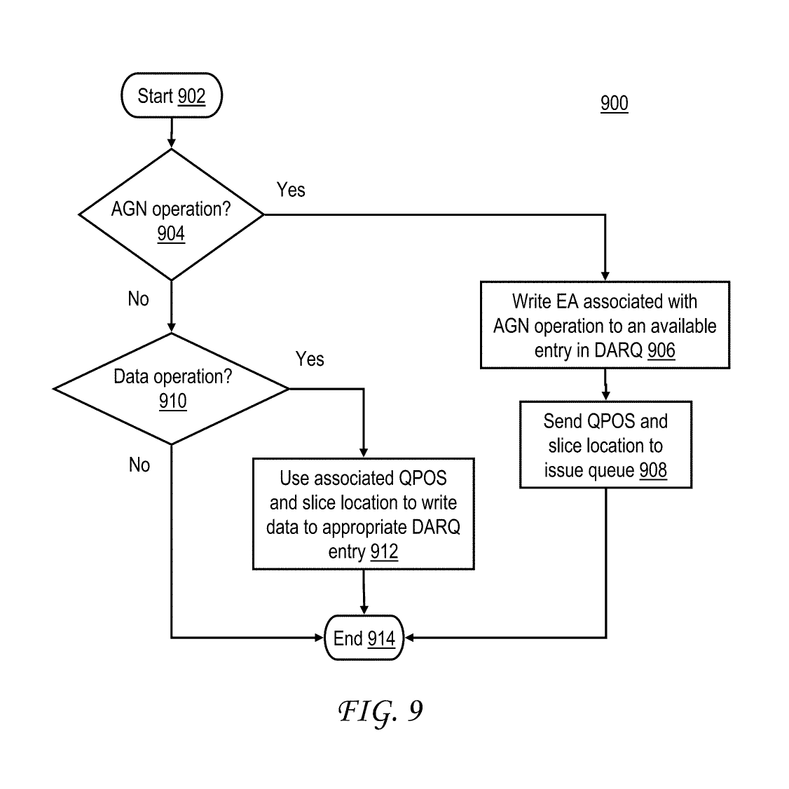

With reference to FIG. 9, an exemplary process 900 for handling a store instruction, according to an embodiment of the present disclosure, is illustrated. Process 900 is initiated in block 902 by, for example, DARQ 322 in response to, for example, receipt of an operation associated with a store instruction (store), e.g., as indicated by an operation code (opcode)). It should be appreciated that a different DARQ 322 is implemented for each slice. Next, in decision block 904, DARQ 322 determines whether the operation is an AGN operation for a store. In response to the operation being an AGN operation for a store control transfers from block 904 to block 906. In block 906, DARQ 322 receives an EA (generated by AGN logic 440) associated with the AGN operation and stores the EA in an available entry in DARQ 322. Next, in block 908, DARQ 322 sends a queue position, a slice location, and an ITAG to identify the store or a slice location and the ITAG to UIQ 214 for the EA associated with the store. Following block 908 control transfers to block 914, where process 900 terminates.

In response to the operation not being an AGN operation control transfers from block 904 to decision block 910. In block 910, DARQ 322 determines whether the operation is a data operation for a store (e.g., as indicated by an opcode). In response to the operation not being a data operation for a store control transfers from block 910 to block 914, where process 900 terminates. In response to the operation being a data operation for a store in block 910 control transfers to block 912. In block 912, in the first embodiment, DARQ 322 uses the queue position and the slice location associated with the data (formatted by data logic 430) to write the associated data to an appropriate entry in an appropriate DARQ 322 that includes the EA for the store. In the second embodiment, DARQ 322 uses the slice location associated with the data to write the associated data and ITAG to a new entry in DARQ 322. From block 912 control transfers to block 914.

Accordingly, techniques have been disclosed herein that advantageously improve store instruction execution in a multi-slice processor architecture.

In the flow charts above, the methods depicted in the figures may be embodied in a computer-readable medium containing computer-readable code such that a series of steps are performed when the computer-readable code is executed on a computing device. In some implementations, certain steps of the methods may be combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing, but does not include a computer-readable signal medium. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible storage medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable signal medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage subsystems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of operating a processor, comprising:
receiving, at an issue queue, a store instruction, wherein the store instruction has an associated address generation (AGN) operation and an associated data operation;
issuing, from the issue queue, the AGN operation to AGN logic associated with a pipeline slice in response to all source operands for the AGN operation being ready, wherein the AGN logic is configured to generate an address for the store instruction;
receiving, by the issue queue, confirmation for the AGN operation, wherein the confirmation includes an indication of the pipeline slice that performed the AGN operation; and
in response to receiving the confirmation and a source operand for the data operation being ready, issuing, by the issue queue, the data operation to data logic associated with the pipeline slice indicated by the confirmation, wherein the data logic is configured to format data for the store instruction.

2. The method of claim 1, wherein the issue queue is a unified issue queue that is configured to issue instructions to a fixed-point execution unit (FXU) and a load/store unit (LSU).

3. The method of claim 2, wherein the AGN operation is issued from an LSU port of the unified issue queue and the data operation is issued from an FXU port of the unified issue queue.

4. The method of claim 1, wherein the address generated by the AGN logic is an effective address (EA).

5. The method of claim 4, wherein a portion of the EA indicates the pipeline slice.

6. The method of claim 1, wherein the confirmation also includes a position in a queue of the pipeline slice where the address is stored and the method further comprises:
storing, by the issue queue, the indication of the pipeline slice and the position in the queue in conjunction with the store instruction in an entry in the issue queue.

7. The method of claim 1, wherein the confirmation also includes an instruction tag (ITAG) for the store instruction and the method further comprises:
issuing, by the issue queue, the indication of the pipeline slice and the ITAG in conjunction with the data operation.

8. A processor, comprising:
an instruction cache; and
an issue queue coupled to the instruction cache, wherein the issue queue is configured to:
receive a store instruction, wherein the store instruction has an associated address generation (AGN) operation and an associated data operation;
issue the AGN operation to AGN logic associated with a pipeline slice in response to all source operands for the AGN operation being ready, wherein the AGN logic is configured to generate an address for the store instruction;
receive confirmation for the AGN operation, wherein the confirmation includes an indication of the pipeline slice that performed the AGN operation; and
in response to receiving the confirmation and a source operand for the data operation being ready, issue the data operation to data logic associated with the pipeline slice indicated by the confirmation, wherein the data logic is configured to format data for the store instruction.

9. The processor of claim 8, wherein the issue queue is a unified issue queue that is configured to issue instructions to a fixed-point execution unit (FXU) and a load/store unit (LSU).

10. The processor of claim 9, wherein the AGN operation is issued from an LSU port of the unified issue queue and the data operation is issued from an FXU port of the unified issue queue.

11. The processor of claim 8, wherein the address generated by the AGN logic is an effective address (EA).

12. The processor of claim 11, wherein a portion of the EA indicates the pipeline slice.

13. The processor of claim 8, wherein the confirmation also includes a position in a queue of the pipeline slice where the address is stored and the issue queue is further configured to:
store the indication of the pipeline slice and the position in the queue in conjunction with the store instruction in an entry in the issue queue.

14. The processor of claim 8, wherein the confirmation also includes an instruction tag (ITAG) for the store instruction and the issue queue is further configured to:
issue the indication of the pipeline slice and the ITAG in conjunction with the data operation.

15. A data processing system, comprising:
a data storage subsystem; and
a processor coupled to the data storage subsystem, wherein the processor is configured to:
receive a store instruction, wherein the store instruction has an associated address generation (AGN) operation and an associated data operation;
issue the AGN operation to AGN logic associated with a pipeline slice in response to all source operands for the AGN operation being ready, wherein the AGN logic is configured to generate an address for the store instruction;
receive confirmation for the AGN operation, wherein the confirmation includes an indication of the pipeline slice that performed the AGN operation; and
in response to receiving the confirmation and a source operand for the data operation being ready, issue the data operation to data logic associated with the pipeline slice indicated by the confirmation, wherein the data logic is configured to format data for the store instruction.

16. The data processing system of claim 15, wherein the issue queue is a unified issue queue that is configured to issue instructions to a fixed-point execution unit (FXU) and a load/store unit (LSU).

17. The data processing system of claim 16, wherein the AGN operation is issued from an LSU port of the unified issue queue and the data operation is issued from an FXU port of the unified issue queue.

18. The data processing system of claim 15, wherein the address generated by the AGN logic is an effective address (EA).

19. The data processing system of claim 18, wherein a portion of the EA indicates the pipeline slice.

20. The data processing system of claim 15, wherein the confirmation also includes and an instruction tag (ITAG) for the store instruction and the processor is further configured to:
issue the indication of the pipeline slice and the ITAG in conjunction with the data operation.
